(19) United States
(12) Patent Application Publication
(10) Pub. No.: US 2024/0098775 A1
(43) Pub. Date: Mar. 21, 2024

(54) METHOD AND NETWORK NODE FOR APPLYING MACHINE LEARNING IN A WIRELESS COMMUNICATIONS NETWORK

(71) Applicant: Telefonaktiebolaget LM Ericsson (publ), Stockholm (SE)

(72) Inventors: Géza SZABÓ, Kecskemét (HU); Levente NÉMETH, Malé Dvorníky (SK)

(21) Appl. No.: 18/274,320

(22) PCT Filed: Feb. 5, 2021
(86) PCT No.: PCT/EP2021/052861

§ 371 Date: Jul. 26, 2023

(51) Int. Cl. H04W 72/543; H04L 41/16; H04W 24/02; H04W 28/02; H04W 72/04

(52) U.S. Cl. CPC H04W 72/543; H04L 41/16; H04W 24/02; H04W 28/0268; H04W 72/04

(57) ABSTRACT

A method and a network node for applying machine learning for training a communication policy controlling radio resources for communication of messages between the network node and a control node operating a remotely controlled device is provided. The network node obtains said messages during one or more communication phases communicated when an initial first communication policy is applied for controlling a Quality of Service, QoS, mode. The network node trains a machine learning model based on said messages and the first communication policy. The network node produces a second communication policy including at least one adjusted QoS mode for at least one communication phase. The network node determines a performance score for the second communication policy in the communication phase(s) based on the radio resources used when communicating using the second communication policy.

### TECHNICAL FIELD

Embodiments herein relate to a method and a network node for applying machine learning in a wireless communication network, for training a communication policy controlling radio resources for communication of messages between the network node and a control node operating a remotely controlled device.

### BACKGROUND

In a typical wireless communication network, wireless devices, also known as wireless communication devices, mobile stations, stations (STA) and/or User Equipment (UE), communicate via a Local Area Network such as a Wi-Fi network or a Radio Access Network (RAN) to one or more core networks (CN). The RAN covers a geographical area which is divided into service areas or cell areas, which may also be referred to as beams or beam groups, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over a radio interface operating on radio frequencies with one or more wireless devices within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a 5G network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Pre-Programmed Robots

FIG. 1 shows a prior art solution for industry 3.0 robotics with pre-programmed position control of a robot arm which lack any flexibility of reprogramming a program or control of a robot. In this case, a control unit in direct wired communication with the robotics may perform any computation regarding e.g. trajectory calculations or kinematics and may further control various operational parameters such as movements, velocity, robotics frequency, power, or servo control.

Remotely Controlled Industry 4.0 Devices

In contrast to FIG. 1, FIG. 2 illustrates an enhanced system for robot control as performed in industry 4.0 where velocity control and trajectory may be computed and reprogrammed during runtime e.g. by an external control entity that could be any suitable computer, server or cloud server communicating over radio e.g. 5G NR with a controller connected to the robot for controlling the robot. In this way, 5G may provide improved flexibility which is often a requirement for cloud robotics and industry 4.0. Furthermore, 5G provides a global communication standard which may support real-time communication with end-to-end latencies below a few milliseconds at high reliability level.

Thus, 5G may be used to provide the necessary features to become an essential part of the infrastructure of future factories and industrial plants e.g. relying or utilizing robotics in industry 4.0 factories or controlling unmanned vehicles, e.g. remotely controlled autonomous land vehicles, cars, trucks or aerial vehicles such as remotely piloted drones.

In some scenarios, cloud robotics applications, e.g. remote control of industrial robotics such as a robot arm using a 5G connection, may or may not rely on real-time processing, however, when processing data during an immediate motion of a robot, e.g. when high accuracy or precision is required, the radio connection quality or processing latency may be of upmost importance as a low radio quality may decrease said precision.

Hence, a problem may arise in effectively utilizing the radio resources in a wireless communication network while ensuring remote radio control of a device, e.g. robot, with required precision.

### SUMMARY

As a part of developing embodiments herein a problem was identified by the inventors and will first be discussed.

In order to achieve high performance with low overhead of radio resource usage, the actions performed by a robot in prior solutions need to be manually set, tagged, or pre-programmed e.g. with appropriate radio quality information for the system being enabled to optimally control the communication and allocation of radio resources. Instead, it has been recognized in the embodiments herein that it is possible to solve this issue by using an architecture in which the programming of suitable radio quality happens automatically in order to minimize the utilized radio resources without relying on manual work while still maintaining low or no impact on operation precision.

According to an aspect of embodiments herein, the object is achieved by a method performed by a network node applying machine learning in a wireless communication network for training a communication policy controlling radio resources for communication of messages between the network node and a control node operating a remotely controlled device.

The network node obtains said messages during one or more communication phases communicated when an initial first communication policy is applied for controlling a Quality of Service, QoS, mode in said communication. The QoS mode is set to one of at least two predefined QoS modes having different levels of QoS for each of said one or more communication phases. The network node then trains a machine learning model based on said messages and the first communication policy. The network node produces a second communication policy based on the machine learning model. The second communication policy comprises at least one adjusted QoS mode for at least one of the one or more communication phases. The network node determines a performance score for the second communication policy in the one or more communication phases based on the radio resources used when communicating using the second communication policy and further based on a reduced operation precision when said one or more communication phases are communicating using the adjusted QoS mode. When the determined performance score indicates a performance exceeding a predetermined performance, the network node applies the second communication policy to said communication between the network node and the control node.

According to another aspect of embodiments herein, the object is achieved by a network node comprising a processor and a memory wherein said memory comprises instructions executable by said processor whereby said network node is configured to apply machine learning in a wireless communication network for training a communication policy controlling radio resources for communication of messages between the network node and a control node operating a remotely controlled device. The network node is further configured to:
obtain said messages during one or more communication phases communicated when an initial first communication policy is applied for controlling a Quality of Service, QoS, mode in said communication, wherein the QoS mode is adapted to set to one of at least two predefined QoS modes having different levels of QoS for each of said one or more communication phases,
train a machine learning model based on said messages and the first communication policy,
produce a second communication policy based on the machine learning model, wherein the second communication policy comprises at least one adjusted QoS mode for at least one of the one or more communication phases,
determine a performance score for the second communication policy in the one or more communication phases based on the radio resources used when communicating using the second communication policy and further based on a reduced operation precision when said one or more communication phases are communicated using the adjusted QoS mode, and
when the determined performance score indicates a performance exceeding a predetermined performance, apply the second communication policy to said communication between the network node and the control node.

Since the obtained messages and the first communication policy are used to train a machine learning model, the machine learning model is useful to produce a second communication policy which communicates using reduced radio resources in communication phases with adjusted QoS mode causing no or low reduced operation impact when applied to the communication between the network node and control node for controlling the remotely controlled device.

Hence, an automatic way to find which communication phases to communicate using a certain level of QoS, while maintaining the precision of the remote control system is achieved, thus minimizing the consumption of radio resources between the network node and the control node, while not allowing any, or minimal increase of error in operating the controlled device.

### BRIEF DESCRIPTION OF THE DRAWINGS

Examples of embodiments herein are described in more detail with reference to attached drawings in which:

FIG. 1 is a schematic block diagram illustrating an arrangement for controlling a device, according to the prior art.

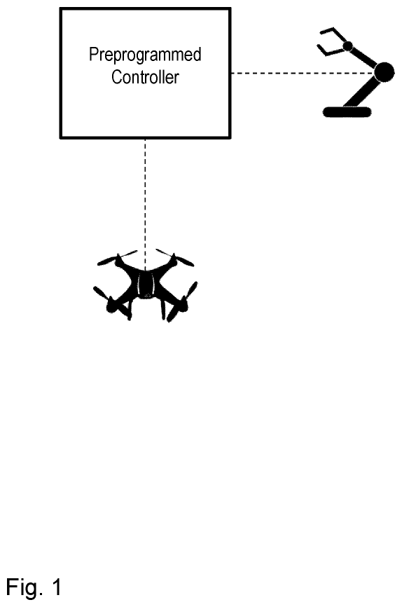

FIG. 2 is a schematic block diagram illustrating another arrangement for controlling a device, according to the prior art.

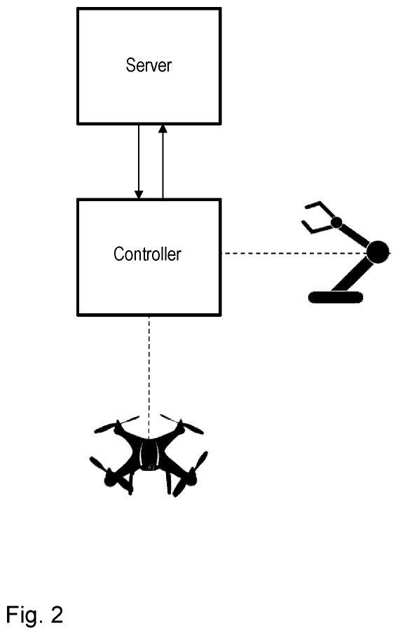

FIG. 3 is a schematic block diagram illustrating another arrangement for controlling a device, according to the prior art.

FIG. 4 is a schematic block diagram illustrating a wireless communications network where embodiments herein may be implemented.

FIG. 5 is a flowchart illustrating an example of actions in a network node according to some embodiments.

FIG. 6 is a flowchart illustrating another example of actions in a network node according to some embodiments.

FIG. 7 is a schematic block diagram illustrating functions in a network node according to some embodiments.

FIG. 8 is a schematic block diagram illustrating how a machine learning model may be trained according to some embodiments.

FIG. 9a-b are schematic block diagrams illustrating examples of how a network node may be structured according to some embodiments.

### DETAILED DESCRIPTION

While in the following description, a robot is frequently used as an example of a remotely controlled device, the described examples are also applicable to any other type of remotely controlled device. Further, while it is mostly described herein that movements of the robot are remotely controlled as an illustrative example it should be understood that any other operations of a remotely controlled device could be controlled using the embodiments herein which are thus not limited to the controlling of movements and trajectories of a robot or other device.

Effects of Communication in Industry 4.0 Devices

In some scenarios, remotely controlled devices e.g. robotics controlled via a radio interface may comprise a different set of inherent characteristics of the underlying system than a robot controlled by a pre-programmed controller.

To control a robot properly, e.g. with high precision, high frequency communication of robot control related information may be needed, such as e.g. velocity commands and encoder state information. This may be required to maintain necessary functionality during remote control.

Decoupling Controller and Processing Circuitry

Separating or decoupling the robot from a remote control system or the like, e.g. robotic arm controller and associated resources e.g. the controller controlling the robot and a network node e.g. base station or server comprising a processing unit for processing or computing, an increased latency or network delay is introduced for both sensing and actuating processes due to relying on radio communication between the controller and the network node.

Increased Computational Power

Due to decoupling computation, the remote robot control system may further have higher computational performance, e.g. by using cloud computing resources or dedicated hardware in a server or computing system. Cloud computing resources may further be used to train machine learning models e.g. by applying reinforcement learning on how to operate a robot.

E.g. Levine, Sergey & Pastor, Peter & Krizhevsky, Alex & Quillen, Deirdre (2016), in “Learning Hand-Eye Coordination for Robotic Grasping with Deep Learning and Large-Scale Data Collection”, The International Journal of Robotics Research 2016 describe a learning based approach to hand-eye coordination for robotic grasping from monocular images. Thus using convolutional neural networks as a machine learning model may be utilized to achieve automated learning of hand-eye coordination for grasping for a real-time control of a robot.

Increased Flexibility

Hence, a remote robot control system may due to the decoupling of resources, achieve higher flexibility, e.g. decoupling of the data processing with the sensing and actuating operations.

In this way, the remote robot control system may use increased computational power as above, and further be adapted or configured to account for the increased network delay between the remote robot control system and the robot.

E.g. in U.S. Pat. No. 8,947,522B1 a robotic device is communicating with a server, wherein the actions and communications performed between the server and robotic device are determined based on a measured latency level in the communication between the robotic device and the server.

Control Effects of Network Performance

A trajectory of moving a remotely controlled device such as a robot arm is affected by the various network latency setups due to control operations e.g. steering, movement, gripping, or controlling operations from a remote control system such as e.g. a Cyber-Physical Production System (CPPS). In this way, trajectories executed by a robot may differ increasingly from the planned trajectories with higher latency or network delay.

In this way, QoS e.g. with respect to latency, jitter, packet error rate, bandwidth, or queue priority may be seen as a factor on operation precision of controlling a robot using a remote control system. In some scenarios herein, QoS may also be defined as Quality of Control (QoC) of remote operations wherein QoC may be define which level of QoS is required for performing a specific action with regards to e.g. precision or accuracy constraints. QoC may also in some scenarios be defined as a feeling a haptic device provides to the user, wherein the haptic device may be a high precision robotic arm.

In this way, it is possible to characterize a QoC-aware (QoCa) radio resource allocation strategy that may be based on the categorization of communicating phases of e.g. a robotic arm movement into e.g. high or low QoC phases.

Throughout this description, the terms QoS and QoC are used interchangeably and can be regarded more or less as synonyms in this context, to basically indicate precision and accuracy of remote control operations and their radio resource consumption. Some examples of how different levels of QoC, or QoS, could be defined in practice are presented below.

Low QoS

Arm movements requiring low QoS may be the ones that, while necessary, do not need to be executed with high precision. E.g., if a robotic arm needs to complete a task at some point of a conveyor belt, the movement of the arm may not require a high precision and thus may operate using lower QoS.

High QoS

As a non-limiting but illustrative example, movements requiring high QoS may involve critical operations such as a joint movement of a robot arm which needs to be accurately performed in order to successfully complete a required tasks e.g. when placing a part piece on a tray using a robot arm.

Hence, the precise position and orientation where the part is placed may require a high QoS and may be more important than the speed to complete the task.

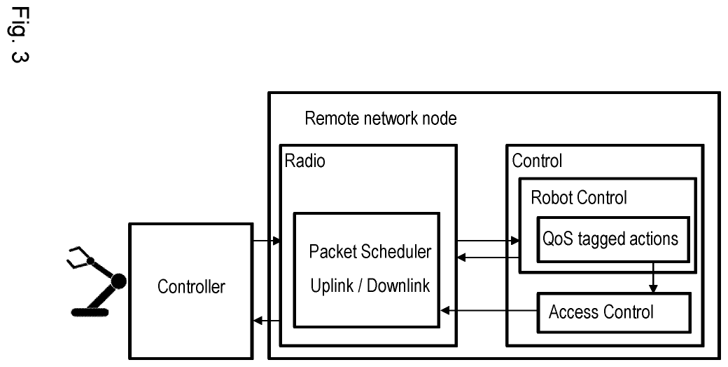

E.g. WO2019238215A1 discloses a method and system for maintaining the performance of a wired industry 3.0 controller in a remote control system while minimizing network or radio resources used, when switching from a wired control to a wireless remote control in an edge cloud. This is performed by relaxing network performance e.g. using low QoS and less radio resources when performing actions related to lower precision, and keeping high network performance e.g. demanding high QoS when performing actions related to a high precision. This is illustrated by the setup in FIG. 3, wherein a controller controlling a robot receives control operations e.g. instructions from a remote network node. The remote network node may then communicate control operations with the controller over radio, and wherein a packet scheduler may control the QoS of uplink and downlink packets. The remote network node further communicates e.g. robot control operations of which actions a robot should take, and wherein the actions are tagged manually by expert user knowledge with an associated QoS level, and wherein an access control module accordingly influences the packet scheduler to schedule communication based on the necessary or demanded QoS.

While it may be possible to maintain high precision operating using reduced radio resources using the above described procedure, a problem arises as certain operations have to be manually tagged with a specific QoS level. Thus, the expert user may need to have a complete knowledge of all communication and operations necessary in the system to accomplish a certain task, which may be impossible for systems comprising a complex or large amount of operations. Furthermore, the expert user may need to inspect every action to evaluate its proper QoS level, which is time consuming, and may cause inaccuracies if an unsuitable QoS level is set.

Embodiments herein thus provide identification of QoS communication phases using machine learning, e.g. an automatic QoS identification system. As indicated above, a high precision constraint may require a high QoS level and a low precision constraint enables a relaxed QoS level in embodiments herein.

The embodiments may relate to controlling a remotely controlled device, e.g. a robot or drone using e.g. cloud resources and may comprise accounting for safe operation of the robot. This may be performed by automating e.g. a QoS tagging process by Deep Packet Inspection (DPI), ensuring awareness of communicated robot status or operation. In this way, a machine learning model may be trained to identify a suitable communication policy that may further be deployed for allocating radio resources when remotely controlling the remotely controlled device to minimize or at least reduce the amount of radio resources used during communication phases allowing low precision and allocating more radio resources when operating at high precision using, e.g. high QoS or URLLC, such as when controlling essential high precision movement of the remotely controlled device, e.g. a robot or drone.

Hence, it may possible to achieve an automatic procedure of determining the communication phases of when to relax communication e.g. low QoS and use less radio resources, and of when it is necessary to have high precision and thus use more radio resources to maintain high network quality e.g. high QoS. The machine learning model may further be retrained in any deployment of the embodiments herein and does not need to rely on knowing the exact underlying operations communicated e.g. only if the operations may need high precision or not. Furthermore, if increased computational power of machine learning is available, it may be possible to achieve more improvements in savings of radio resource compared to manually tagging actions e.g. due to ease of scaling the identification to larger or more complex communications which may not be possible for an expert user to tag manually.

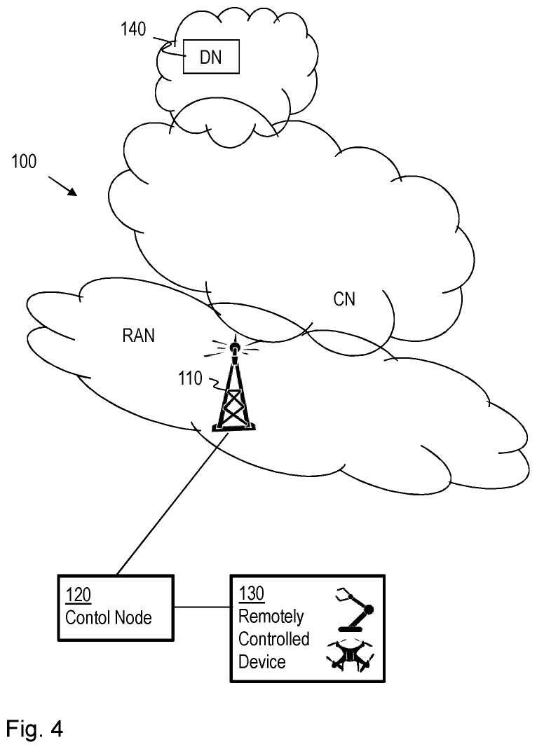

Embodiments herein relate to wireless communication networks in general. FIG. 4 is a schematic overview depicting a wireless communications network 100. The wireless communications network 100 comprises one or more RANs and one or more CNs. The wireless communications network 100 may use a number of different technologies, such as Wi-Fi, LTE, LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMAX), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A network node operates in the wireless communications network 100 such as e.g. a network node 110. This node provides radio coverage in e.g. a cell which may also be referred to as a beam or a group of beams, provided by the network node 110.

The network node 110 may be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNodeB B), a gNB, a base transceiver station, a radio remote unit, an Access Point Base Station, a base station router, a transmission arrangement of a radio base station, a stand-alone access point or any other network unit capable of communicating with a wireless device within the service area served by the network node 110 depending e.g. on the first radio access technology and terminology used. The radio network node 110 may be referred to as a serving radio network node and communicates with a control node 120 with Downlink (DL) transmissions to the control node 120 and Uplink (UL) transmissions from the control node 120.

In the wireless communication network 100, one or more control nodes, such as e.g. the control node 120 operate one or more remotely controlled devices such as e.g. a remotely controlled device 130. The control node 120 may also referred to as a controller, robot controller, or drone controller, depending on how it is deployed. The control node 120 may communicate via one or more Access Networks (AN), e.g. RAN, to one or more core networks.

Methods herein may be performed by the Network node 110. As an alternative, a Distributed Node (DN) 140 and functionality, e.g. comprised in a Cloud as shown in FIG. 4, may be used for performing or partly performing the methods herein.

The remotely controlled device 130 may be any device to be remotely controlled over wireless or radio such as e.g. NR and may be a robot, robot arm, drone, or unmanned vehicle. Hence the term robot or robotics as used above and below e.g. in association with industry 4.0 or radio communication should not be viewed as limiting and may be interpreted to be any remotely controlled device e.g. drone or unmanned vehicle being controlled remotely over radio communication e.g. 5G NR.

The above described problem is addressed in a number of embodiments, some of which may be seen as alternatives, while some may be used in any combination whenever suitable and depending on implementation.

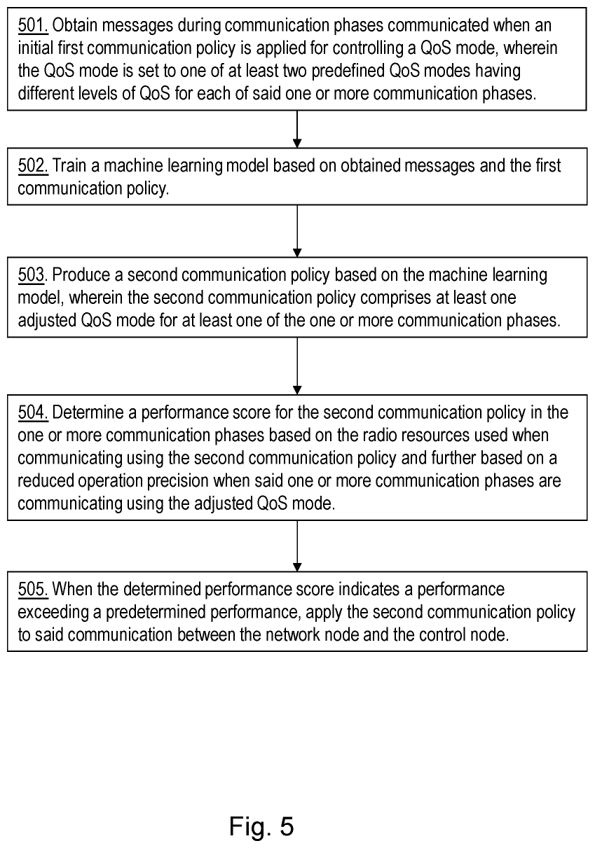

FIG. 5 shows example embodiments of actions performed by the network node 110 applying machine learning in a wireless communication network 100 for training a communication policy controlling radio resources for communication of messages between the network node 110 and the control node 120 operating the remotely controlled device 130.

This example comprises the following actions, which actions may be taken in any suitable order.

Action 501

According to an example scenario, the network node 110 applies machine learning for training a communication policy controlling radio resources for a communication between the network node 110 and the control node 120. Hence, in order to train a machine learning model, the network node may need training data such as e.g. the messages communicated for training the machine learning model.

Hence, the network node 110 obtains said messages during one or more communication phases communicated when an initial first communication policy is applied for controlling a Quality of Service, QoS, mode in said communication, wherein the QoS mode is set to one of at least two predefined QoS modes having different levels of QoS for each of said one or more communication phases.

In some embodiments the least two predefined QoS modes having different levels of QoS may comprise any suitable number of predefined QoS modes. The QoS modes may be ranked by their respective different levels of QoS from a low QoS level to a high QoS level.

In some embodiments, the different levels of QoS may be based on a QoS Class Identifier (QCI) value.

In some embodiments said messages comprises a status indication received from the control node 120 and control operations sent to the control node 120 for controlling the remotely controlled device 130. Thus, the network node 110 may be aware of the operations the remotely controlled device is performing. In these embodiments the network node 110 may then also be aware of the status of the remotely controlled device 110 when performing said operations.

In some embodiments, e.g. when communicating control operations to the control node 120 and the QoS mode is set to a high level, the high level QoS mode comprises the network node 110 demanding Ultra-Reliable Low-Latency Communication, URLLC, for communicating with the control node 120.

In some embodiments, URLLC is demanded when the QoS mode is the QoS mode of the highest level among the least two predefined QoS modes having different levels.

Action 502

To automatically achieve an effective communication policy the network node 110 trains a machine learning model based on said messages and the first communication policy.

In some embodiments, training the machine learning model is further based on a first performance score of the first communication policy. In this way, the machine learning model, e.g. a neural network, may be able to learn which communication policies are associated with a specific performance score, and further enable the network node 110 to adjust the machine learning model, e.g. adjust weights in the neural network, based on e.g. the first performance score, to adapt the model to produce a communication policy with a higher performance score.

The training may be performed iteratively e.g. training may be based on multiple communication policies communicating control operations with the control node 120 for controlling the remotely controlled device 130 in the same or different way. Hence, in some embodiments the machine learning model is further trained based on a third communication policy, second messages communicated between the network node 110 and the control node 120 using the third communication policy, and a third performance score associated with the third communication policy.

In some embodiments the second messages may comprise control operations controlling for the remotely controlled device 130 in another distinct manner.

In this way, it may be possible for the network node 110 to more efficiently train a machine learning model to produce a high performance communication policy based on any messages communicated with the control node 120 for controlling the remotely controlled device 130.

Action 503

To evaluate new policies, the network node 110 produces a second communication policy based on the machine learning model, wherein the second communication policy comprises at least one adjusted QoS mode for at least one of the one or more communication phases. In this way, the second communication policy may thus be differ in at least one level of QoS of at least one of the one or more communication phases of the first communication policy. In some embodiments, the at least one adjusted QoS mode is changed from a high level QoS to a low level QoS.

In some embodiments the at least one adjusted QoS mode is changed to a QoS mode having any other suitable level of QoS.

To learn new communication policies e.g. for evaluating if they are good enough or to apply them, the network node 110 produces a second communication policy based on the machine learning model, wherein the second communication policy comprises at least one adjusted QoS mode for at least one of the one or more communication phases. In this way, the second communication policy may thus be differ in at least one QoS level of at least one of the one or more communication phases of the first communication policy. In some embodiments, the at least one adjusted QoS mode is changed from a high level QoS to a low level QoS.

In some embodiments changing from a high level QoS to a low level QoS may comprises a relative change from a higher level to a lower level.

Action 504

To evaluate if the second communication policy is performing better than the first communication policy, the network node 110 determines a performance score for the second communication policy in the one or more communication phases based on the radio resources used when communicating using the second communication policy and further based on a reduced operation precision when said one or more communication phases are communicating using the adjusted QoS mode. In this way, it may be possible to evaluate how well the second communication policy is performing based on both the usage of radio resources and precision.

In some embodiments, a performance score may be determined to be lower than the performance score of the first communication policy if there is any or non-negligible reduction in operation precision.

Some embodiments may involve a feedback mechanism for learning long-term how changing QoS mode affect an overall change in precision. Therefore, the network node 110 determining a performance score for the second communication policy may further comprise computing the performance score for the second communication policy based on an intermediate reward for selecting a high level or low level QoS mode for the at least one adjusted QoS mode and further based on an end reward for a change in operation precision caused by said selection.

In some embodiments the network node 110 determining a performance score for the second communication policy may comprise any of simulating or measuring the communication performed between the network node 110 and the control node 120 using the second communication policy. In some embodiments, the network node 110 may use any combination of simulating and measuring said communication.

Action 505

To further be able to apply a communication policy of higher performance, the network node may, when the determined performance score indicates a performance exceeding a predetermined performance, apply the second communication policy to said communication between the network node 110 and the control node 120.

In some embodiments the network node 110 applying the second communication policy to said communication between the network node 110 and the control node 120 may comprise sending the control operations to the control node 120 and receiving the status indication from the control node 120 using the second communication policy

In some embodiments the network node 110 applying the second communication policy may require the determined performance score to indicate a performance exceeding a predefined performance by a predefined threshold.

In some embodiments wherein the determined performance score is not indicating a performance exceeding a predetermined performance, the actions performed by the network node 110 may be iterated and further comprise obtaining third messages, training the machine learning model based on said third messages and the first communication policy, producing a fourth communication policy, determining a performance score for the fourth communication policy, and applying the fourth communication policy when the performance score for the fourth communication policy indicates a performance exceeding a predetermined performance. In some embodiments, the actions may be iterated multiple times.

The above embodiments will now be further explained and exemplified below.

Example Scenario Comprising a Feedback

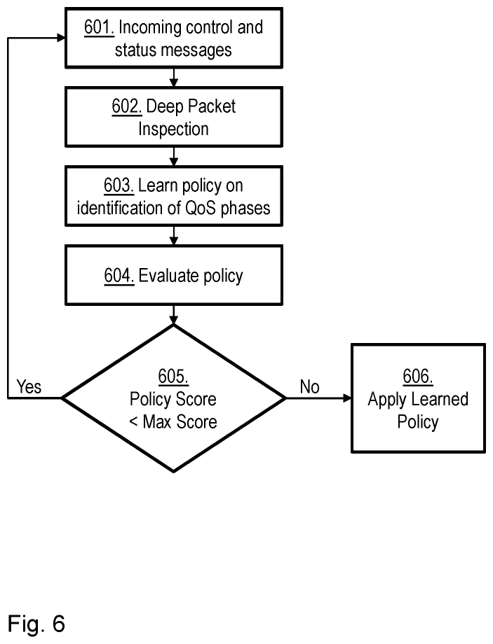

FIG. 6 shows another example of actions that could be performed by the network node 110, further discussed as actions 601-606 below.

Action 601

In some embodiments the network node 110 obtains incoming control and status messages wherein the messages indicates. The control messages may indicate e.g. what control operations the control node 120 is using for control the remotely controlled device 130. The status messages may indicate the corresponding status for operating the remotely controlled device using said control messages.

This action may correspond to action 501 above.

Action 602

In some embodiments, the network node 110 may perform DPI e.g. using a dedicated DPI module, for obtaining e.g. contents and structures of the incoming messages. In some embodiments the DPI module may be a packet parser, e.g. the DPI module may know the structure of an incoming message, e.g. packet and may parse the headers and payloads of said message one by one. In some embodiments, the DPI module may be based on using deterministic finite state machines for processing the incoming messages.

This action may correspond to action 501 above.

Action 603

In some embodiments, the network node 110 may use a machine learning model to learn a policy, e.g. a communication policy based on identifying the QoS level necessary for each communication phase. The machine learning model may learn to produce a high performance or an optimal communication policy based on training the model on different policies applying different QoS level and its corresponding performance evaluation.

This action may correspond to actions 502 and 503 above.

Action 604

The policy e.g. the communication policy produced by the trained machine learning model may further evaluate a performance score based on how much radio resources the communication policy is using and based on evaluating based on how much errors or inaccuracies a remotely controlled device performs by using said communication policy.

This action may correspond to action 504 above.

Action 605

In some embodiments the network node 110 may compare the performance score of the evaluated communication policy to the evaluation of executing a communication policy with all communication phases are set to high QoS e.g. comprising a predetermined max performance.

In some embodiments the evaluated communication policy has a lower performance score than the communication policy of which all communication phases are set to high QoS. In these embodiments, the training of the machine learning model may continue, and another iteration of training and evaluation may be performed. In some of these embodiments, new input data may be used for training the machine learning model, e.g. different incoming control and status messages. Some embodiments further comprises training the machine learning model with the evaluated communication policy and the corresponding performance score.

In some embodiments the evaluated communication policy has a higher performance score than the communication policy of which all communication phases are set to high QoS. Hence, a higher performing communication policy is produced and may be used in communication between the network node 110 and control node 120 for controlling the remotely controlled device 130.

This action may correspond to actions 504 and 505 above.

Action 606

The communication policy may be utilized when communicating between the network node 110 and control node 120 for controlling the remotely controlled device 130.

This action may correspond to action 505 above.

Automatic QoS

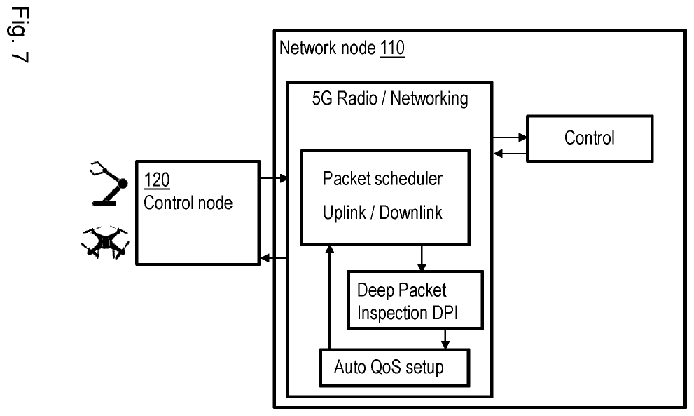

FIG. 7 shows an example illustration of how functions in the network node 110 may be operable when in communication with the control node 120 controlling a remotely controlled device 130 such as e.g. a robot arm or drone.

In some embodiments the network node 110 performs an automatic process of tagging actions e.g. related to communicated packets or messages in one or more communication phases to conform to a high level or low level QoS mode. To achieve this, messages may be communicated between the network node 110 and the control node 120 using a first communication policy. Further the messages e.g. uplink or downlink packets comprising e.g. status or control operations may be processed by a DPI module, which ensures that an automatic QoS setup module, e.g. part of the network node 110, may be aware of the messages communicated with the control node 120 using a first communication policy. The network node 110 may accordingly also be aware of the contents of the messages, such as e.g. the current status or control operations of the remotely controlled device 130 e.g. a robot or drone. The control operations may further be retrieved from a control entity in the network node 110 controlling control operations e.g. instructions to be performed by the remotely controlled device 130. The control operations may further be sent to the control node 120. The control node 120 may then receive the control operations and use said control operations to control the remotely controlled device 130. Accordingly, the control node 120 may retrieve status from the remotely controlled device 130 and send the status as status messages to the network node 110.

To automatically identify or tag the communication phases e.g. one or more time periods of communication that may be relaxed, a machine learning model may be trained to identify which communication phases these are.

In some embodiments, the machine learning model may be trained based on one or more communication policies, e.g. the first communication policy together with associated said messages, e.g. the uplink packets, control operations or status and e.g. a score associated with each communication policy.

In some embodiments, any communication policy may be an encoded mapping of a QoS level, communication phase and when that communication phase is to occur, e.g. by a runtime parameter such as e.g. total time since initiating the communication between the network node 110 and the control node 120. In some embodiments the communication phase is a time interval such as e.g. one second intervals. In some embodiments, the encoded mapping may comprise the time interval of a communication phase.

The machine learning module may be part of the Auto QoS setup module as illustrated in FIG. 7, and may in some embodiments further be applied to the communication between the network node 110 and control node 120 by e.g. using a second communication policy which may control QoS and scheduling of messages or packets using a packet scheduler such as e.g. the packet scheduler illustrated in FIG. 7.

Feedback Learning

Emerging AI applications, such as e.g. training the machine learning model as in action 502 may operate in dynamic environments and may need to react to changes or adjustments, e.g. different QoS in different communication phases, in their environment such as e.g. the messages obtained or status indications. Furthermore training the machine learning model may need to take sequences of actions to accomplish long-term goals such as e.g. the second or third communication policy evaluated to a performance score indicating higher performance than a predefined performance.

Machine learning algorithms that could be useful in the embodiments herein, may thus both use gathered data, e.g. the obtained messages in the network node 110 and may further explore a space of possible actions, e.g. adjusting a QoS level of a communication phase in a communication policy to achieve long term goals such as e.g. maximizing a performance score based on reduced radio resources and reduced operation precision.

Above features are naturally framed within the paradigm of feedback or reinforcement learning which deals with learning to operate continuously within an uncertain environment based on delayed and limited feedback.

In some embodiments, the machine learning herein may thus comprise a delayed feedback. The delayed feedback may relate to an end reward related to giving a bonus reward if an action causes a good end result, e.g. increased performance score for an adjusted QoS level which may cause the same or improved operation precision, e.g. a similar or lower error rate, of the remotely controlled device 130.

The central goal of a feedback or reinforcement machine learning application is to learn a policy, e.g. a first, second or third communication policy, which may be a mapping from the state of the environment e.g. the obtained messages, to a choice of action e.g. a QoS level to be executed during a communication phase of a communication policy. The policy learned, e.g. the first, second or third communication policy may yield an effective performance over a longer period of time, e.g. piloting a drone with no error or minimizing radio resources when communicating with a robot arm.

In some embodiments, any machine learning method herein may need to perform simulation to evaluate machine learning models or to evaluate the communication policies. In this way, it is possible to explore one or more choices of action sequences e.g. the choice of QoS level in any communication phase, and to more effectively learn about the long-term consequences of said choices or action e.g. how much radio resources used through the communication and the accuracy, precision or errors relating to the communication.

In some other embodiments, instead of simulating the system, the methods herein interact with the physical environment.

In some other embodiments, a mix of simulation and interactions with the physical environment such as e.g. measuring on real hardware is performed.

In some embodiments, the training of the machine learning model may be distributed e.g. to the DN 140, to improve the policy e.g. the first, second or third communication policy based on data generated through said simulations or interactions with the physical environment.

Policy Training

The embodiments herein thus relate to multiple communication policies, e.g. the afore-mentioned first, second or third communication policies, which may be intended to provide solutions to control problems. Further, the policies such as e.g. the first, second or third communication policies may relate to policies served in an interactive closed-loop and open-loop control scenarios.

In some embodiments, training the machine learning model may comprise training a machine learning model with a defined an observation space. In these embodiments, the observation space may be defined based on one or more observations related to joints of a robot such as e.g. any one or more out of: position, rotation e.g. radian or degree interval e.g. −π to π, velocity e.g. rad/sec, effort or force applied, e.g. in Newton, or any gripper status such as e.g. hold, open, or release.

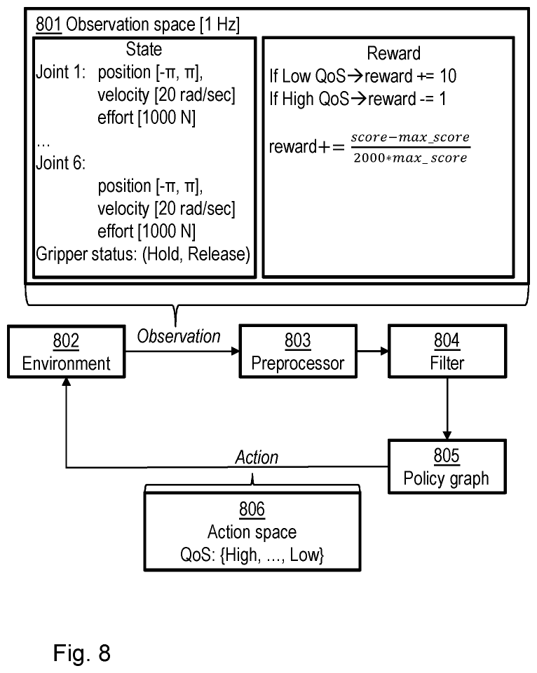

FIG. 8 illustrates an embodiment for training a machine learning model using a selected scenario, e.g. which messages to be communicated between the network node 110 and the control node 120 for controlling the remotely controlled device 130. The embodiment may further comprise a policy graph 805 which may comprise a communication policy such as e.g. the first, second or third communication policy. In this way, an adjusted communication policy such as e.g. the second or third communication policy may be produced, e.g. producing a second communication policy, by adjusting the QoS level for a communication phase, or part of the adjusted communication policy. The adjustment may be associated with choosing an action in an action space 806, wherein the action space 806 comprises two or more levels of QoS e.g. a high, medium, or low QoS level. To further evaluate the action chosen from said action space 806, FIG. 8 illustrates an environment in which these actions are taken place, such as related to e.g. the communicated messages between the network node 110 and the control node 120 communicating using the second communication policy adjusted based on said chosen action. Furthermore, an observation may be made with regards to the environment 802, e.g. the communication policy wherein the observation may be related to computing or determining a short term or intermediate reward related to e.g. a reduced use of radio resource and computing or determining a long term or end reward related to e.g. the operation precision or error rate. The intermediate reward may then be based on the intermediate effect of the action e.g. based on the effect of reduced radio resources by adjusting the QoS level. The end reward may be based on whether or not the reduction of reduced radio resources has any effect on a runtime or end error of the control node 120 operating the remotely controlled device 130.

In some embodiments, based on the observation, the policy, e.g. the first, second, or third communication policy may serve as a basis for training the machine learning model, e.g. by adjusting weights in a neural network to adjust the policy graph. This may be performed by pre-processing the policy and filter out redundant data or any unnecessary outliers. Hence, it may be possible to reiterate the method and continue to explore the action space 806 and observation space 801 to further train a more efficient model for producing communication policies.

In some embodiments every iteration of evaluating a policy, an environment, or the messages communicated between the network node 110 and control node 120 may be selected randomly from predefined messages, e.g. with a uniform distribution from a set of predefined multiple messages. In this way, it may be possible to train a machine learning model to produce a communication policy based on many different types of communication scenarios.

Rewards

In some embodiments the performance score is computed based on an intermediate reward and an end reward for a chosen action, e.g. one or more adjusted QoS modes for a communication phase.

In some embodiments the intermediate reward may be based on a reward given for an action taken during a communication, e.g. more points may be awarded for adjusting a QoS mode to use a lower QoS level in a communication phase.

In some embodiments, every communication phase, e.g. every second, using a low QoS level may be associated with a reward for computing a score e.g. +10 points for low QoS and −1 point for a high QoS.

In some embodiments, computing an intermediate reward for communication phases is based on an inverse relationship to the QoS level such as e.g. a lower reward is given for a higher QoS level, and a higher reward is determined for a lower QoS level.

In some embodiments computing a performance score for a communication policy may further relate to an end reward computed e.g. when a remotely controlled device completes its task The end reward may be computed based on predetermined points for fulfilling any one or more out of the following constraints: a correct position, orientation, fulfilling a required task. In these embodiments the end reward is further based on a bonus score e.g. if all or several of above constraints are fulfilled.

In some embodiments, first points, e.g. +1 point, may be a score for each fulfilled constraint and second points, e.g. +1 point, may be the associated bonus score for fulfilling several or all above constraints.

In some embodiments the constraints are based on a precision or error rate for controlling the remotely controlled device 130.

In some embodiments, fulfilling these constraints or retrieving precision or error rate may be determined in any suitable manner, e.g. by using a camera or X-ray scanner to feedback a measurement or quality check, by other sensors measuring the system, or determined using the obtained robot status messages. In some embodiments, this may be determined based on a comparison with a predefined precision or error metric.

In some embodiments, a reward may be based on any above score and a predetermined maximum performance.

In some embodiments, a high performance score indicates high performance and a low performance score indicates low performance. In this way, a communication policy may have higher performance if its performance score is higher than the performance score of another communication policy.

To perform the method actions above, the network node 110 comprises a processor and a memory wherein said memory comprises instructions executable by said processor whereby said network node 110 is configured to apply machine learning in a wireless communication network 100 for training a communication policy controlling radio resources for communication of messages between the network node 110 and the control node 120 operating the remotely controlled device 130.

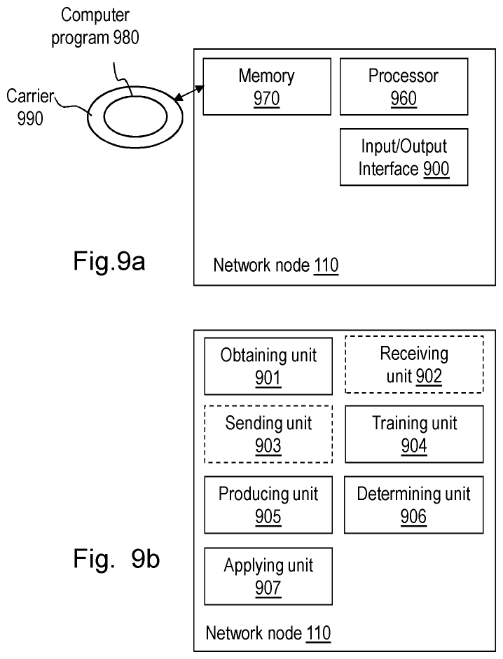

The network node may comprise an arrangement illustrated in FIGS. 9a and 9b.

The network node 110 may comprise an input and output interface 900 configured to communicate with a control node such as the control node 120. The input and output interface 900 may comprise a wireless receiver (not shown) and a wireless transmitter (not shown) for radio communication with the control node 120.

The network node 110 may further be configured to, e.g. by means of an obtaining unit 901 in the network node 110, to obtain said messages during one or more communication phases communicated when an initial first communication policy is applied for controlling a Quality of Service, QoS, mode in said communication, wherein the QoS mode is adapted to set to one of at least two predefined QoS modes having different levels of QoS for each of said one or more communication phases.

The obtaining unit may in some embodiments be a receiving unit 902 in the network node 110, and the network node 110 may further be configured to receive status indication from the control node 120.

The obtaining unit may in some embodiments be a sending unit 903 in the network node 110, and the network node 110 may in these embodiments the network node 110 may further be configured to send control operations to the control node 120.

Thus, said messages may comprise a status indication received from the control node 120, e.g. by means of the obtaining unit 901 or the receiving unit 902, and control operations sent to the control node 120, e.g. by means of the obtaining unit 901 or the sending unit 903, for controlling the remotely controlled device 130.

The network node 110 may further be configured to, e.g. by means of a training unit 904 in the network node 110, train a machine learning model based on said messages and the first communication policy.

The network node 110 may be configured to train, e.g. by means of the training unit 904, the machine learning model further based on a first performance score of the first communication policy.

The network node 110 may be configured to train, e.g. by means of the training unit 904, the machine learning model based on a third communication policy, second messages communicated between the network node 110 and the control node 120 using the third communication policy, and a third performance score associated with the third communication policy.

The network node 110 may further be configured to, e.g. by means of a producing unit 905 in the network node 110, produce a second communication policy based on the machine learning model, wherein the second communication policy comprises at least one adjusted QoS mode for at least one of the one or more communication phases.

The network node 110 may be configured to change the at least one adjusted QoS mode from a high level QoS to a low level QoS.

The high level QoS mode may comprise the network node 110 to be configured to demand Ultra-Reliable Low-Latency Communication, URLLC, for communicating with the control node 120.

The network node 110 may further be configured to, e.g. by means of a determining unit 906 in the network node 110, determine a performance score for the second communication policy in the one or more communication phases based on the radio resources used when communicating using the second communication policy and further based on a reduced operation precision when said one or more communication phases are communicated using the adjusted QoS mode.

The network node 110 may be configured to determine, e.g. by means of the determining unit 906, a performance score for the second communication policy by computing the performance score for the second communication policy based on an intermediate reward for a selection of a high level or low level QoS mode for the at least one adjusted QoS mode and further adapted to be based on an end reward for a change in operation precision caused by said selection.

The network node 110 may be configured to determine, e.g. by means of the determining unit 906, a performance score for the second communication policy by configuring the network node 110 to simulate or measure the communication performed between the network node 110 and the control node 120 using the second communication policy.

The network node 110 may further be configured to, e.g. by means of an applying unit 907 in the network node 110, when the determined performance score indicates a performance exceeding a predetermined performance, apply the second communication policy to said communication between the network node 110 and the control node 120.

The network node 110 may further be configured to apply, e.g. by means of the applying unit 907, the second communication policy to said communication between the network node 110 and the control node 120 wherein the second communication policy comprises sending the control operations to the control node 120, e.g. by means of the obtaining unit 901 or the sending unit 903, and receiving the status indication from the control node 120, e.g. by means of the obtaining unit 901 or the receiving unit 902, using the second communication policy.

The network node 110 may be configured to apply, e.g. by means of the applying unit 907, the second communication policy by requiring the determined performance score to indicate a performance exceeding a predetermined performance by a predefined threshold.

The embodiments herein may be implemented through a respective processor or one or more processors, such as the processor 960 of a processing circuitry in the network node 110 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110

The network node 110 may further comprise a memory 970 comprising one or more memory units. The memory 970 comprises instructions executable by the processor in network node 110. The memory 970 is arranged to be used to store e.g. information, indications, data, configurations, and applications to perform the methods herein when being executed in the network node 110.

In some embodiments, a computer program 980 comprises instructions, which when executed by the respective at least one processor 960, cause the at least one processor of the network node 110 to perform the actions above.

In some embodiments, a respective carrier 990 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1. A method in a network node for applying machine learning in a wireless communication network, for training a communication policy controlling radio resources for communication of messages between the network node and a control node operating a remotely controlled device, the method comprising:
obtaining said messages during one or more communication phases communicated when an initial first communication policy is applied for controlling a Quality of Service, QoS, mode in said communication, wherein the QoS mode is set to one of at least two predefined QoS modes having different levels of QoS for each of said one or more communication phases,
training a machine learning model based on said messages and the first communication policy,
producing a second communication policy based on the machine learning model, wherein the second communication policy comprises at least one adjusted QoS mode for at least one of the one or more communication phases,
determining a performance score for the second communication policy in the one or more communication phases based on the radio resources used when communicating using the second communication policy and further based on a reduced operation precision when said one or more communication phases are communicating using the adjusted QoS mode,
when the determined performance score indicates a performance exceeding a predetermined performance, applying the second communication policy to said communication between the network node.

2. The method according to claim 1 wherein said messages comprises a status indication received from the control node and control operations sent to the control node for controlling the remotely controlled device, and wherein applying the second communication policy to said communication between the network node and the control node comprises sending the control operations to the control node and receiving the status indication from the control node using the second communication policy.

3. The method according to claim 1 wherein determining a performance score for the second communication policy further comprises computing the performance score for the second communication policy based on an intermediate reward for selecting a high level or low level QoS mode for the at least one adjusted QoS mode and further based on an end reward for a change in operation precision caused by said selection.

4. The method according to claim 1 wherein determining a performance score for the second communication policy comprises any of simulating or measuring the communication performed between the network node and the control node using the second communication policy.

5. The method according to claim to claim 1 wherein training the machine learning model is further based on a first performance score of the first communication policy.

6. The method according to claim 5 wherein the machine learning model is further trained based on a third communication policy, second messages communicated between the network node and the control node using the third communication policy, and a third performance score associated with the third communication policy.

7. The method according to claim 1 wherein the at least one adjusted QoS mode is changed from a high level QoS to a low level QoS.

8. The method according to claim 1 wherein a high level QoS mode comprises the network node demanding Ultra-Reliable Low-Latency Communication, URLLC, for communicating with the control node.

9. The method according to claim 1 wherein applying the second communication policy requires the determined performance score to indicate a performance exceeding a predefined performance by a predefined threshold.

10. A computer program comprising instructions, which when executed by a processor, causes the processor to perform actions according to claim 1.

11. A carrier comprising the computer program of claim 10, wherein the carrier is one of an electronic signal, an optical signal, an electromagnetic signal, a magnetic signal, an electric signal, a radio signal, a microwave signal, or a computer-readable storage medium.

12. A network node comprising a processor and a memory wherein said memory comprises instructions executable by said processor whereby said network node is configured to apply machine learning in a wireless communication network, for training a communication policy controlling radio resources for communication of messages between the network node and a control node operating a remotely controlled device, the network node further being configured to:
obtain said messages during one or more communication phases communicated when an initial first communication policy is applied for controlling a Quality of Service, QoS, mode in said communication, wherein the QoS mode is adapted to set to one of at least two predefined QoS modes having different levels of QoS for each of said one or more communication phases,
train a machine learning model based on said messages and the first communication policy,
produce a second communication policy based on the machine learning model, wherein the second communication policy comprises at least one adjusted QoS mode for at least one of the one or more communication phases,
determine a performance score for the second communication policy in the one or more communication phases based on the radio resources used when communicating using the second communication policy and further based on a reduced operation precision when said one or more communication phases are communicated using the adjusted QoS mode,
when the determined performance score indicates a performance exceeding a predetermined performance, apply the second communication policy to said communication between the network node and the control node.

13. The network node according to claim 12 wherein said messages comprise a status indication received from the control node and control operations sent to the control node for controlling the remotely controlled device, and wherein the network node is further configured to apply the second communication policy to said communication between the network node and the control node wherein the second communication policy comprises sending the control operations to the control node and receiving the status indication from the control node using the second communication policy.

14. The network node according to claim 12 wherein the network node is configured to determine a performance score for the second communication policy by computing the performance score for the second communication policy based on an intermediate reward for a selection of a high level or low level QoS mode for the at least one adjusted QoS mode and further adapted to be based on an end reward for a change in operation precision caused by said selection.

15. The network node according to claim 12 wherein the network node is configured to determine a performance score for the second communication policy by configuring the network node to simulate or measure the communication performed between the network node and the control node using the second communication policy.

16. The network node according to claim 12 wherein the network node is configured to train the machine learning model further based on a first performance score of the first communication policy.

17. The network node according to claim 16 wherein the network node is configured to train the machine learning model based on a third communication policy, second messages communicated between the network node and the control node using the third communication policy, and a third performance score associated with the third communication policy.

18. The network node according to claim 12 wherein the network node is configured to change the at least one adjusted QoS mode from a high level QoS to a low level QoS.

19. The network node according to claim 12 wherein a high level QoS mode comprises the network node configured to demand Ultra-Reliable Low-Latency Communication, URLLC, for communicating with the control node.

20. The network node according to claim 12 wherein the network node is configured to apply the second communication policy by requiring the determined performance score to indicate a performance exceeding a predefined performance by a predefined threshold.
